(19) United States
(12) Patent Application Publication
(10) Pub. No.: US 2021/0267406 A1
(43) Pub. Date: Sep. 2, 2021

(54) Infuser Technology For Drinking Containers

(71) Applicant: Michael Rechsteiner, Laguna Hills, CA (US)

(72) Inventor: Michael Rechsteiner, Laguna Hills, CA (US)

(21) Appl. No.: 16/805,699

(22) Filed: Feb. 29, 2020

(51) Int. Cl. A47J 31/06; A47J 31/00; A47J 31/20

(52) U.S. Cl. CPC A47J 31/0636; A47G 19/16; A47J 31/20; A47J 31/005

(57) ABSTRACT

A modular filter for a vacuum mug comprises a mug cap and a first filter basket. The mug cap has a bottom opening and a threaded wall. The modular filter further comprises a first cylindrical connector having a first opening, second opening, and circular screen filter positioned between the first and second opening. The bottom opening of the mug cap is attached to the first opening of the cylindrical connector, and the filter basket is attached to the second opening of the cylindrical connector. The first filter basket comprises a cylinder having cylindrical screen filter, a top opening and bottom base. Its top opening is attached to the second opening of the cylindrical connector. The bottom base comprises filtration holes.

### FIELD OF THE INVENTION

The present invention relates to beverage containers, and, more specifically, to an infuser that has multiple baskets for multiple uses and purposes.

### BACKGROUND OF THE INVENTION

Coffee and tea pots have been used for centuries to brew coffee or tea. The common method has been pouring hot water over the coffee grinds or tea leafs, and allowing the water to infuse and extract the soluble solids from the brew product. A later improvement provided a straining means located near the opening's neck permitting the brewing to take place without having to sift the brew leftover from the beverage. This improvement was advantageous but required removing the straining device prior to pouring. This drawback has been overcome with a cap that comprises both an opening for pouring the beverage and an opening for the strainer/infuser.

As people get busier, they do not have time for brewing a perfect cup of coffee or tea notwithstanding a brewing pot that conveniently separates the brew leftover and the brew. Furthermore, they also want to keep their beverages warmer longer so they can get the best tastes. These desires have been met with a vacuum mug, or thermal mug, that insulates the beverage inside from the temperature outside, and has become a modern convenience that busy coffee or tea drinkers cannot function without. A vacuum mug with a cap that comprises both a strainer or infuser, and an opening for sipping has allowed a coffee or tea drinker to brew her coffee or tea on the go as if the user takes a brewing pot with her. The vacuum mug keeps the hot water hot, so the coffee or tea inside the strainer or infuser has time to brew while the user travels to the workplace.

The more convenient and functionally better vacuum mugs get, the more often people use them. Thus, naturally, they want their mugs to be ever larger or taller, to contain larger quantity of their drinks, so that they do not have to refill their mugs so often. Since the mugs are getting larger, they post a problem of inconsistent quality of the brewed beverage. For example, over extraction, due to brewing ground coffee in consistently hot water for a long period, results in intensely bitter coffee, while under extracted coffee, due to cooler water and/or shorter brewing period, is usually sour and lacking in complexity. With a larger or taller mug, this problem will be exacerbated where a small strainer/filter is attached under the cap near the top, and half empty beverage is at the bottom of the tall mug, and the brewing stops when the user drinks too fast. This scenario is actually common when people are busier.

However, a single deep filter will not be a good solution either because the entire amount of the brew product stay submerged at the bottom of the filter, and the longer the coffee or tea is submerged in the water, the longer the brewing time and, thus, the more likely an over extraction, and bitter beverages. Thus, it is desirable that the user has some finer control of the brewing.

Furthermore, for drinkers who like to add flavor ingredients to their beverages, they do not have a way to add the flavor ingredients except putting the ingredients directly into the coffee or tea leaves before brewing. In some instances, mixing flavor ingredients and brew product Is not desirable. In other instances, submerging the flavor ingredients in the beverage for a long period is not desirable. Perhaps, in these instances the drinker only wants a mild flavor.

Since a mug can keep both cold and hot beverage colder or warmer, respectively, longer than without one, a user can perhaps use it for hot coffee or tea in the morning and cold soda in the afternoon. In this use scenario, however, the user needs a versatile mug that allows hot and cold beverages, and, furthermore, a finer control of the temperature of the beverages so they can get the best tastes. Therefore, it is desirable for a strainer or infuser that could accommodate all the foregoing desired features of a modern mug or cup.

Currently, no mugs on the market offered this versatility and the features. Therefore, it is desirable to have a spill-proof and versatile cap to increase the utility of a mug.

### OBJECT OF THE INVENTION

Accordingly, it is the object of this invention to create a mug cap that is versatile, multi-functional, and, thus, increases its utility.

It is the object of this invention to create a mug cap that allows mobile brewing brew products.

It is the object of this invention to create a mug infuser that is versatile allowing mobile brewing of diverse brew products and ingredients.

It is an object of the invention to create a mug infuser that is configurable to brew multiple ingredients.

It is an object of the invention to create a mug cap that is spill-proof and versatile.

It is an object of the invention to create a mug with a cap that fits a coffee or tea POD machine.

### SUMMARY OF INVENTION

A modular filter for a mug comprises a mug cap and a first filter basket. The mug cap has a bottom opening and a threaded wall. The modular filter further comprises a first cylindrical connector having a first and second opening, and a circular screen filter positioned between the first and second opening. The bottom opening of the mug cap is attached to the first opening of the cylindrical connector, and the filter basket is attached to the second opening of the cylindrical connector. The first filter basket is comprised of a cylinder having a cylindrical screen filter, a top opening and a bottom base. The top opening is attached to the second opening of the cylindrical connector. The bottom base is comprised of filtration holes.

In one embodiment, the modular filter further comprises a second cylindrical connector having a first and second opening, and a circular screen filter positioned between the first and second opening. The first filter basket is attached to the first opening of the second cylindrical connector and a second filter basket is attached to the second opening of the second cylindrical connector. The second filter basket is comprised of a cylinder having a cylindrical screen filter, a top opening and bottom base. Its top opening is attached to the second opening of the second cylindrical connector. The bottom base is comprised of filtration holes.

In another embodiment, the modular filter further comprises a third cylindrical connector having a first and second opening, and a circular screen filter positioned between the first and second opening. The second filter basket is attached to the first opening of the third cylindrical connector, and a third filter basket is attached to the second opening of the third cylindrical connector. The third filter basket is comprised of a cylinder having cylindrical screen filter, a top opening and a bottom base. Its top opening is attached to the second opening of the third cylindrical connector. The bottom base is comprised of filtration holes.

In another embodiment, the cylindrical screen filter of the first filter basket is comprised of circular filtration holes.

In another embodiment, the cylindrical screen filter of the first filter basket is comprised of elongated filtration slits.

In another embodiment, the cylindrical screen filter of the second filter basket is comprised of circular filtration holes.

In another embodiment, the cylindrical screen filter of the second filter basket is comprised of elongated filtration slits.

In another embodiment, the modular filter further comprises a cylindrical cooling stick suitable for fitting within the first filter basket.

In another embodiment, the modular filter further comprises a cylindrical cooling stick suitable for fitting within the second filter basket.

In another embodiment, the modular filter further comprises a cylindrical cooling stick suitable for fitting within the third filter basket.

### BRIEF DESCRIPTION OF THE DRAWINGS

These and other features and advantages of the invention will not be described with reference to the drawings of certain preferred embodiments, which are intended to illustrate and not to limit the invention, and in which

FIG. 1 is a perspective view of an embodiment of a cap.

FIG. 2 is a perspective view of an embodiment of a cap with an infuser attached.

FIG. 3 is an exploded view of an exemplary infuser.

FIG. 4 is a perspective view of a cooling device made to fit the present infuser.

### DETAILED DESCRIPTION OF THE INVENTION

Some embodiments are described in detail with reference to the related drawings. Additional embodiments, features, and/or advantages will become apparent from the ensuing description or may be learned by practicing the invention. The following description is not to be taken in a limiting sense, but is made merely for the purpose of describing the general principles of the invention. The steps described herein for performing methods form one embodiment of the invention, and, unless otherwise indicated, not all of the steps must necessarily be performed to practice the invention, nor must the steps necessarily be performed in the order listed. It should be noted that references to “an” or “one” or “some” embodiment(s) in this disclosure are not necessarily to the same embodiment, and such references mean at least one.

The present invention has been conceived with the aim of addressing one or more of the current mug or cup infusers' limitations. More specifically, the present invention is directed to a mug cap that is spill-proof, versatile, and multi-functional to solve the current limitations.

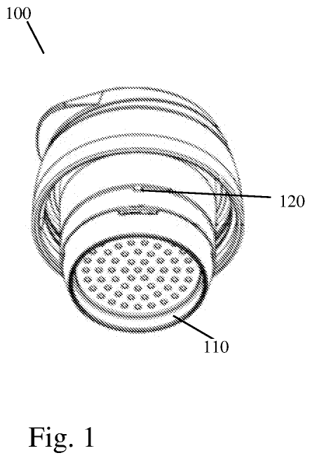

Referring to FIG. 1, in this embodiment, a cap 100 is shown without an attached infuser. The cap comprises several concentric cylindrical sections, with gradually smaller radiuses, with a bottom opening 110. The bottom 110 is perforated to let liquids and brews to flow through, but filter out the brew wastes before a user drinks the brews or beverages. On the outer wall of the cylindrical section, there are tabs 120 that are the tabs acting male pins of a bayonet attachment mechanism. It is appreciated there are a variety of attachment methods can be employed, such as mating threads on the wall of the cylindrical sections as seen on a screw cap. The female halves of the bayonet mount will be disclosed in subsequent figures and their descriptions.

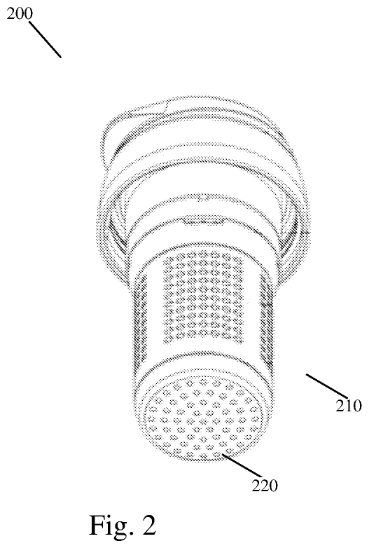

Referring to FIG. 2, in this embodiment, a cap 200 is shown assembled with an filter basket 210. The filter basket 210 comprises a cylindrical screen filter, a top opening, and a perforated bottom 220. In this embodiment, the filter basket's screen filter comprises round holes. It is appreciated that in another embodiment the holes can be elongated. This equally applies to holes on the bottom of the cap and filter basket. On the lip of the top opening, there are L-shaped slots of the bayonet mount, matching and receiving the male pins on the cylindrical section of the cap's 200 bottom opening, disclosed foregoing. It is appreciated that mating threads can be employed to attach the filter basket 210 to the cap 200. In such an embodiment, the outer wall of the cylindrical section of the cap's bottom opening is male threaded. And the inner wall of cylindrical filter basket 210 near the lip of the top opening is female threaded. The cap 200 is screwed into the filter basket to attach them. The filter basket 210 comprises a cylindrical section with a cylindrical screen filter, and the bottom 220 comprises filtration holes.

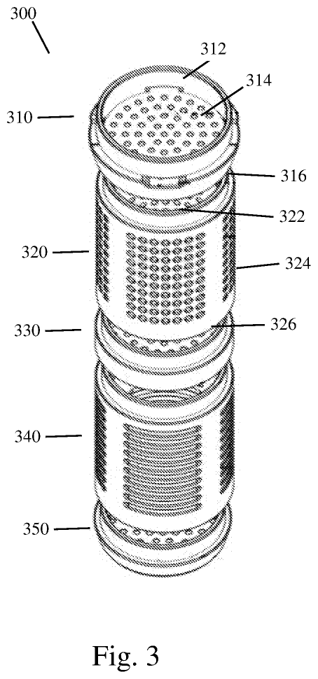

Referring to FIG. 3, in this embodiment, an exploded view of an infuser 300 with multiple filter baskets is shown. The infuser 300 comprises a first cylindrical connector 310 that in turn comprises a first opening 312, a screen filter 314, and a second opening 316. The screen filter 314 is disposed between the first and second opening, 312 and 316 respectively, and filter out brew wastes as beverages flowing through the screen filter. As foregoing disclosed, the inner wall of the cylindrical connector's first opening 312 is female threaded or cut to create the L-shaped slots of a bayonet mount. Other attachment methods could also be employed to attach a cap's bottom opening to the cylindrical connector's first opening. The outer wall of the cylindrical connector's second opening 316 are male threaded or have protruding tabs for a bayonet mount. The infuser 300 further comprises a cylindrical filter basket 320. As foregoing disclosed, the filter basket 320 comprises a top opening 322, a cylindrical screen filter 324, and a bottom base 326. And, in turn, the filter basket 320 is attached to the cylindrical connector 310 in the same or similar manner to that of the cylindrical connector's 310 attachment to the cap's bottom opening. In this embodiment, the infuser 300 further comprises two more cylindrical connectors, 330 and 350, and one more cylindrical filter basket 340. Usually, the connectors 330 and 350 are copies of the connector 310. However, it is appreciated that they can perform different functions or have a different attachment method, or both.

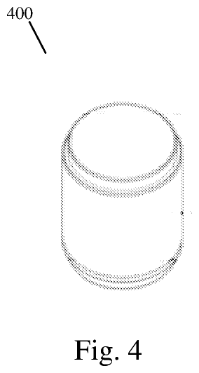

Referring to FIG. 4, an exemplary cooling stick 400 is shown. The cylindrical cooling stick 400 usually contains a refrigerant liquid, and is sealed. This cooling stick 400 is made to fit inside one of the foregoing disclosed filter baskets. A user could freeze one of these cooling sticks overnight, and put it in one of the foregoing disclosed filter baskets when she needs to chill her beverage.

1. A modular filter for a vacuum mug comprises a mug cap and a first filter basket wherein said mug cap has a bottom opening and a threaded wall;
a first cylindrical connector having a first opening and a second opening and a circular screen filter positioned between said first opening and said second opening; wherein said bottom opening of said mug cap is attached to said first opening of said cylindrical connector and said filter basket is attached to said second opening of said cylindrical connector;
said first filter basket is comprised of a cylinder having cylindrical screen filter, a top opening and bottom base wherein said top opening is attached to said second opening of said cylindrical connector; said bottom base is comprised of filtration holes.

2. The modular filter of claim 1 furthering comprising a second cylindrical connector having a a first opening and a second opening and a circular screen filter positioned between said first opening and said second opening; wherein said first filter basket is attached to said first opening of said second cylindrical connector and a second filter basket is attached to said second opening of said second cylindrical connector; second filter basket is comprised of a cylinder having cylindrical screen filter, a top opening and bottom base wherein said top opening is attached to said second opening of said second cylindrical connector; said bottom base is comprised of filtration holes.

3. The modular filter of claim 2 furthering comprising a third cylindrical connector having a a first opening and a second opening and a circular screen filter positioned between said first opening and said second opening; wherein said second filter basket is attached to said first opening of said third cylindrical connector and a third filter basket is attached to said second opening of said third cylindrical connector; said third filter basket is comprised of a cylinder having cylindrical screen filter, a top opening and a bottom base wherein said top opening is attached to said second opening of said third cylindrical connector; said bottom base is comprised of filtration holes.

4. The modular filter of claim 1 wherein said cylindrical screen filter of said first filter basket is comprised of circular filtration holes.

5. The modular filter of claim 1 wherein said cylindrical screen filter of said first filter basket is comprised of elongated filtration slits.

6. The modular filter of claim 1 wherein said cylindrical screen filter of said second filter basket is comprised of circular filtration holes.

7. The modular filter of claim 1 wherein said cylindrical screen filter of said second filter basket is comprised of elongated filtration slits.

8. The modular filter of claim 1 wherein said cylindrical screen filter of said first filter basket is comprised of circular filtration holes.

9. The modular filter of claim 1 wherein said cylindrical screen filter of said second filter basket is comprised of elongated filtration slits.

10. The modular filter of claim 1 further comprising a cylindrical cooling stick suitable for fitting within said first filter basket.

11. The modular filter of claim 2 further comprising a cylindrical cooling stick suitable for fitting within said second filter basket.

12. The modular filter of claim 3 further comprising a cylindrical cooling stick suitable for fitting within said third filter basket.
